(19) United States
(12) Patent Application Publication
(10) Pub. No.: US 2006/0231628 A1
(43) Pub. Date: Oct. 19, 2006

(54) Barcode reader

(76) Inventor: Dung Lung Wei, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/148,244

(22) Filed: Jun. 9, 2005

(30) Foreign Application Priority Data
Apr. 15, 2005 (TW) 094112007

(51) Int. Cl. G06K 7/10

(52) U.S. Cl. 235/462.3

(57) ABSTRACT

A barcode reader is provided, able to turn on/off power or scanning function by itself according to use condition. The main structure thereof comprises a light source module, image sensor, information transferring device, and sensing device, wherein the sensing device is used to sense whether the light signal received by the image sensor changes during an interval of time and control on/off of the power or scanning function of internal elements in the barcode reader according to the change of the light signal. This way, not only the convenience in use can be raised, but also an object of saving energy and increasing lifetime of the barcode reader can be achieved.

### FIELD OF THE INVENTION

The present invention is related to barcode reader and more particularly to a barcode reader being able to turn on/off power or scanning function by itself according to use condition. Not only the convenience in use can be raised, but also an object of saving energy and increasing lifetime of the barcode reader can be achieved.

### BACKGROUND

Since barcode system has various advantages, such as accurately controlling product streams, quickly valuating product sales, conveniently collecting and sorting data, and widely applying in product categories. Therefore, it is common to use in various product labels and markets. The managing efficiency of users is obviously and effectively improved.

The barcode system generally comprises: an encoder for encoding product data to barcode signals, a barcode printer for printing the barcode signals, a barcode reader for scanning and scanning product barcode signals, a decoder for transforming the barcode signals to digital barcode data, and an application interface (API) for corresponding the digital barcode data to product data and continuing post-processing data. Therein, since the barcode reader is the intermediate bridge in data transferring of the entire system, and it is directly controlled and operated by users, it is thus treated as the most important core device. Of all the barcode system products developed in the art, the barcode reader has the most various differences.

Prior art barcode reader and the scanning process thereof are shown in FIG. 1 and FIG. 2. When the user wants to operate the barcode reader 10 to scan the product barcode 20, first the barcode reader 10 has to be accurately aimed at the position of the barcode 20 to be read, as shown in step 210. Next, a switch 14 is pushed to command the light source module 11 set at the front end of the barcode reader 10 to obtain the supply of a working power (not shown) and project a scanning light 12 to the barcode 20 to be read, as shown in step 220. After the barcode 20 to be read is illuminated by the scanning light 12, generated reflection barcode signal 125 is activated by at least one reflective mirror 13 or lens 15 set in the barcode reader 10 to be guided to the image sensor 17, as shown in step 230. The image sensor 17 receives the reflection barcode signal 125, as shown in step 240. The analog type of reflection barcode signal 125 is then transferred to a decoder 18, and the decoder 18 transforms such analog type of reflection barcode signal 125 to digital barcode data 185, as shown in step 250. The decoded digital barcode data 185 is transferred to an information system 195 comprising an application interface therein through a data transferring device 19 and transferring line 193, as shown in step 260.

By the previous mentioned steps, the data scanning operations of barcodes 20 are elementarily completed. Next, go to step 270 to choose whether to continue to use the barcode reader 10 to proceed scanning other barcode data. If choose to continue to use the barcode reader 10 to proceed scanning other barcode data 185, then the user will continue to push the switch 14 to be beneficial to generating the scanning light 12 and proceeding scanning other barcode 20, repeatedly proceeding step 210. If choose not to continue to use the barcode reader 10, then the user could turn off the switch 17 to let the barcode reader 10 go into a sleep state, as shown in step 280.

While the prior art barcode reader 10 can achieve the function of scanning and scanning the product barcode; however, after the user pushes the switch 14 for a long time, he/she will fell tired. At this time, if the light source module 11 at the front end of the barcode reader 10 is changed to a continued scanning light, the previous situation can be effectively avoided from occurring. Nevertheless, if the barcode reader 10 was not used for a long time, but all elements were still supplied power or in scanning state, not only the energy was wasted, but also the lifetime of the barcode reader 10 would be shortened.

### SUMMARY OF THE INVENTION

Accordingly, how to design a novel barcode reader which is not only convenient for users to use in a long time but also saves energy and extends the lifetime of the barcode reader is the key point of the present invention.

It is a primary object of the present invention to provide a barcode reader. By applying a sensing device, when the barcode reader is in an unused state for a long time, the power of internal elements or scanning function thereof could be automatically turned off to achieve saving energy and extending the lifetime of the elements.

It is a secondary object of the present invention to provide a barcode reader. By setting up a sensing device, the barcode reader in a sleep state can be automatically activated to be beneficial to the convenience for users in use.

It is another object of the present invention to provide a barcode reader. The light source module thereof can automatically turn off the scanning light while not in operation thereby reducing the doubt of the scanning light might cause damage to human beings.

To achieve the previous mentioned objects, the present invention provides a barcode reader whose main structure comprises: a light source module for generating a scanning light and aiming light automatically generating a reflection barcode signal after illuminating a barcode; an image sensor provided at a back end of the light source module for selectively receiving and processing one of the reflection barcode signal and an incident light source signal input externally; an information transferring device provided at a back end of the image sensor for transferring the barcode signal processed by the image sensor to an information system; and a sensing device fixed provided in the barcode reader for sensing change of the incident light source signal during an interval as a base of the working power source on/off of the barcode reader.

### BRIEF DESCRIPTION OF DRAWINGS

FIG. 1 is a structural cross sectional diagram of a prior art barcode reader.

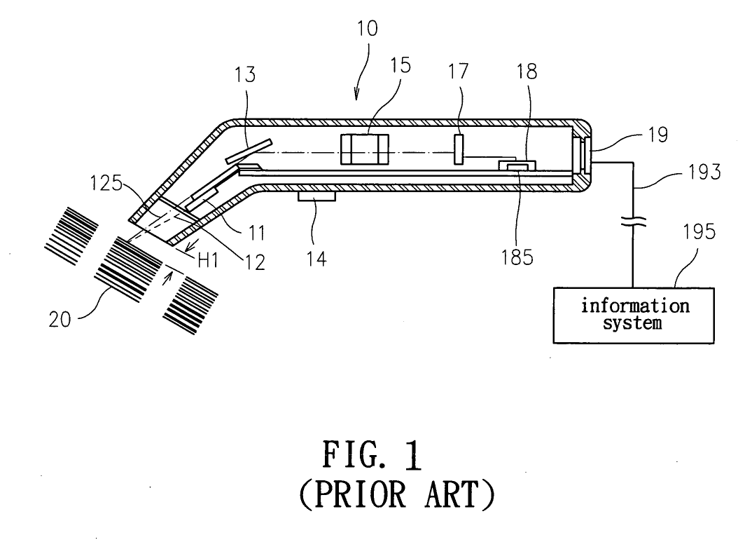

FIG. 2 is flow chart of the scanning operations of the prior art barcode reader.

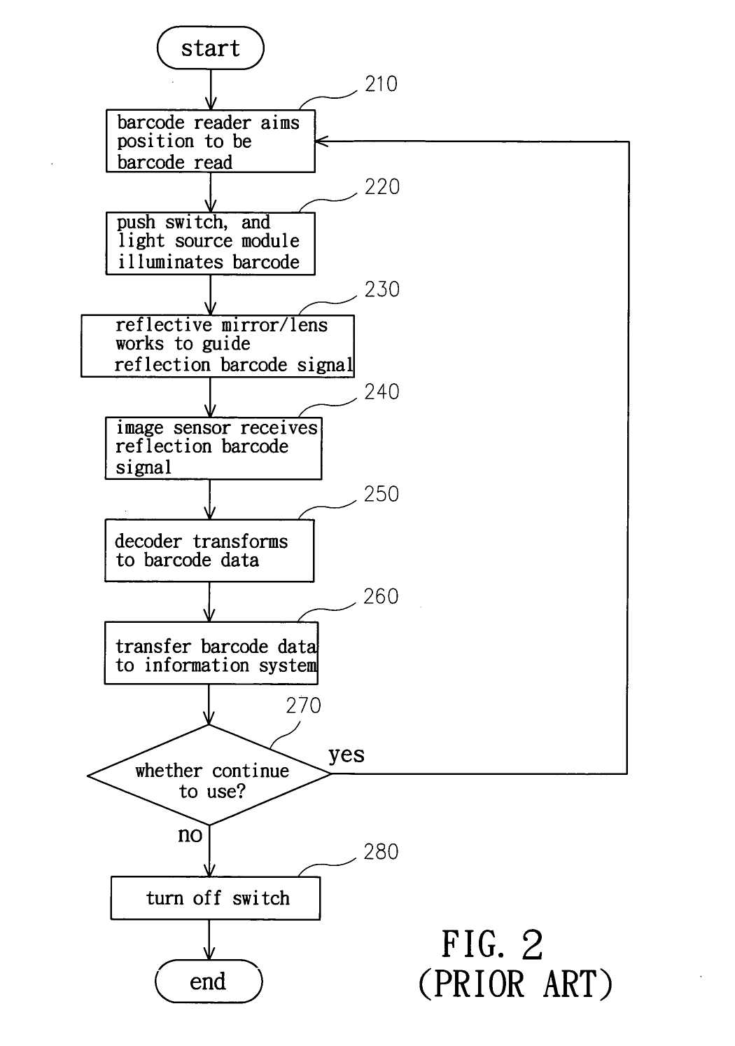

FIG. 3 is a structural cross sectional diagram of a preferred embodiment of a barcode reader of the present invention.

FIG. 4 is flow chart of the scanning operations of the present invention.

FIG. 5 is a structural cross sectional diagram of an alternate embodiment of the present invention.

FIG. 6 is a structural cross sectional diagram of an alternate embodiment of the present invention.

### DETAILED DESCRIPTION

The structural features and the effects to be achieved may further be understood and appreciated by reference to the presently preferred embodiments together with the detailed description.

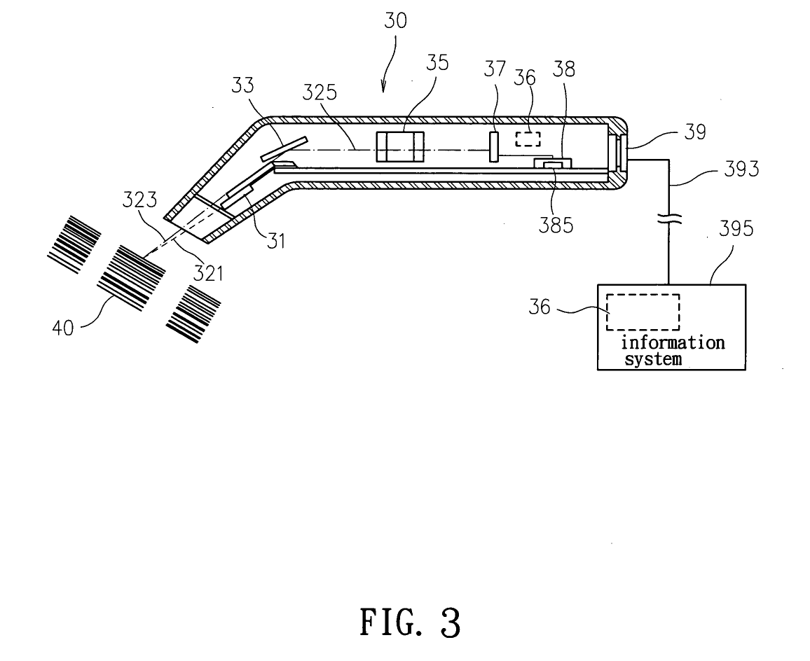

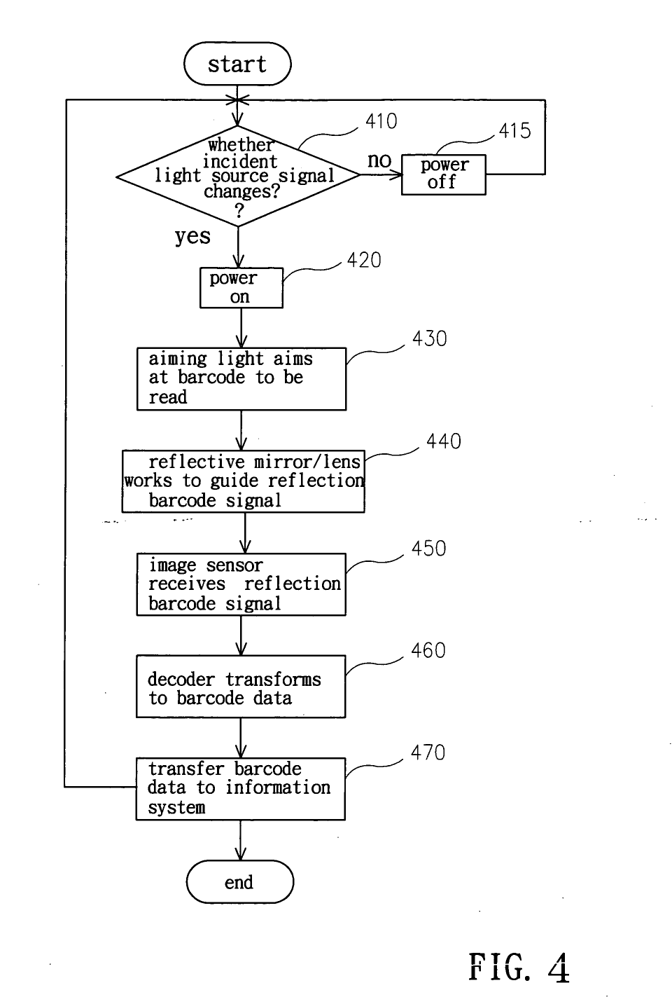

Please refer to FIG. 3 and FIG. 4, respectively a structural cross sectional diagram and a flow chart of the scanning operations of a preferred embodiment of a barcode reader of the present invention. As shown, the barcode reader 30 mainly comprises a light source module 31, reflective mirror 33, lens 35, image sensor 37, decoder 38, and data transferring device 39. Therein, the data transferring device 39 uses a transferring line 393 to connect to an information system 395. A sensing device 36 is further set in the information system 395 or the barcode reader 30. The sensing device 36 is able to detect the change of an incident light source signal 325 received by the image sensor 37 and decide whether the internal elements of the barcode reader 30 can obtain power switch supplied from a working power (not shown) or scanning function based on the change of the incident light source signal 325.

First of all, when all elements of the present invention are in a sleep or off state, the sensing device 36 will keep detecting and comparing whether a received incident light source signal 325 input from exterior changes, as shown in step 410. If not, then keep detecting and let other elements keep in the off or sleep state, as shown in step 415. Otherwise, once the sensing device 36 detects the change of the incident light source signal 325, it makes the barcode reader 30 automatically activate or perform scanning function or make other elements obtain the power supply, as shown in step 420.

Next, the user can aim the scanning light 321 projected by the light source module 31 of the barcode reader 30 at the barcode 40 to be read or make the barcode 40 to be read aim at the scanning light 321, as shown in step 430.

After the barcode 40 to be read is illuminated by the scanning light 321, the generated reflection barcode signal 323 will be treated as an incident light source signal 325 and guided to the image sensor 37 by operating at least one reflective mirror 33 or lens 35 set in the barcode reader 30, as shown in step 440. The image sensor 37 will receive the reflection barcode signal 323, as shown in step 450, and transfer the analog type of reflection barcode signal 323 to a decoder 38. The decoder 38 then transforms the analog reflection barcode signal 323 to a digital barcode data 385, as shown in step 460. The decoded digital barcode data 385 will be transferred to an information system 395 comprising an application interface therein through the data transferring device 39 and the transferring line 393 to complete the scanning operation of the barcode 40 to be read, as shown in step 470.

After the previous steps, the data scanning of barcode 40 has been elementarily completed. Next, it's time to decide whether continuing the barcode reader 30 usage. Therefore, go back to step 410. If continue using the barcode reader 30, then a relative movement has to be occurred between the barcode reader 30 with the barcode 40 during the process to beneficial to scanning other barcode data. However, no matter changing the position of the barcode reader 30 or changing the position of the barcode 40 to achieve the object of the relative movement, the incident light source signal 325 detected by the sensing device 36 would be different because of the movement of the barcode reader 30 or the barcode 40.

At present, the change of the incident light source signal 325 can be used to differentiate whether the barcode reader 30 is in a state of continuously using to be a base of turning on or off the internal power or scanning function in the barcode reader 30. For example, when any relative movement exists between the barcode reader 30 with the barcode 40, the amplitude of the incident light source signal 325 will change accordingly. Therefore, the barcode reader 30 is commanded to keep in the power-on state, and the light source module 31 keeps generating the scanning light 321, and the step 430 to step 470 are repeated to beneficial to the follow-up usage of the barcode reader 30. If no change of the intensity of the incident light source signal 325 in an interval T, then the barcode reader 30 is treated as an idle state, and the sensing device 36 will order the barcode reader 30 to turn off the scanning function or turn off internal element power, as shown in step 415, to achieve a power-off state.

Since the present invention uses the sensing device 36 to automatically perform the control and management of the internal element power or scanning function of the barcode reader 30, when operating the barcode reader 30, the user does not have to keep pushing the switch (14) to use the barcode reader 30. It reduces the burden caused by pushing the switch (14) for a long time for users. Furthermore, when the barcode reader 30 is in an idle state for a long time, the sensing device 36 will sense the idle and turn off the internal element power or scanning function of the barcode reader 30 to achieve an object of saving power and extending lifetime of the product.

Of course, the previous sensing device 36 can also be selected from a hardware device, a software program, or a combination of a software program and the image sensor 37 to achieve the same object of detecting the incident light source signal 325.

While in the previous preferred embodiment of the present invention, a movable barcode reader 30 is specially described, in an alternate embodiment of the present invention, the movable barcode reader 30 can be selected as a fixed barcode reader. Further, the interval T of detecting the incident light source signal 325 by the sensing device 36 can be adjusted according to the operating habit of the users. For example, if the interval T of detecting the change of the light amplitude is chosen as 5 sec., and there is no change of the incident light source signal 325 sensed by the image sensor 37 or the sensing device 36 in 5 sec., the sensing device 36 will turn off the internal element power or scanning function of the barcode reader 30.

Further, the described barcode reader 30 of the present invention uses a transferring line 393 to connect to an information system 395 and uses the transferring line 393 as a transferring interface therebetween. However, in reality, the transferring line 393 can be replaced by a wireless transferring system, such as infrared ray transfer or blue tooth, etc.

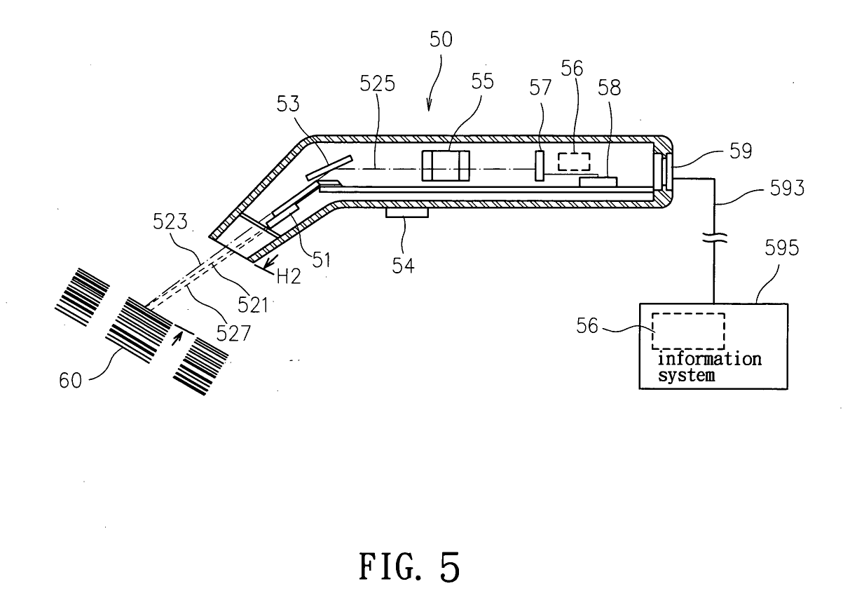

Additionally, please refer to FIG. 5, a structural cross sectional diagram of an alternate embodiment of the present invention. As shown, the barcode reader 50 also comprises a light source module 51, reflective mirror 53, lens 55, image sensor 57, decoder 58, data transferring device 59, and a sensing device 56 for detecting the change of the incident light source signal 525. When the sensing device 56 detects the change of the incident light source signal 525, an aiming light 527 is automatically generated. The aiming light 527 can guide the users to accurately place the barcode reader 50 to a correct position aiming at the barcode 60 to be read. The user can further push a switch 54 to make the light source module 51 generate a scanning light 521 which in turn becomes a reflection barcode signal 523 by reflected by barcode 60. After the reflection barcode signal 523 is guided into the barcode reader 50, it becomes a new incident light source signal 525 to complete the follow-up scanning of the barcode 60.

By the aiming light 527 being pre-guidance of the scanning operation, when operating the barcode reader 50, the position of the barcode 60 to be read is easily to be chosen from various product barcodes, and the follow-up illuminating operation of the scanning light 521 is implemented. To this end, the working distance H2 between the barcode reader 50 with the barcode 60 to be read can be longer than the operating distance (H1) of the prior art barcode reader (10) to be more suitable to long distance operating environment.

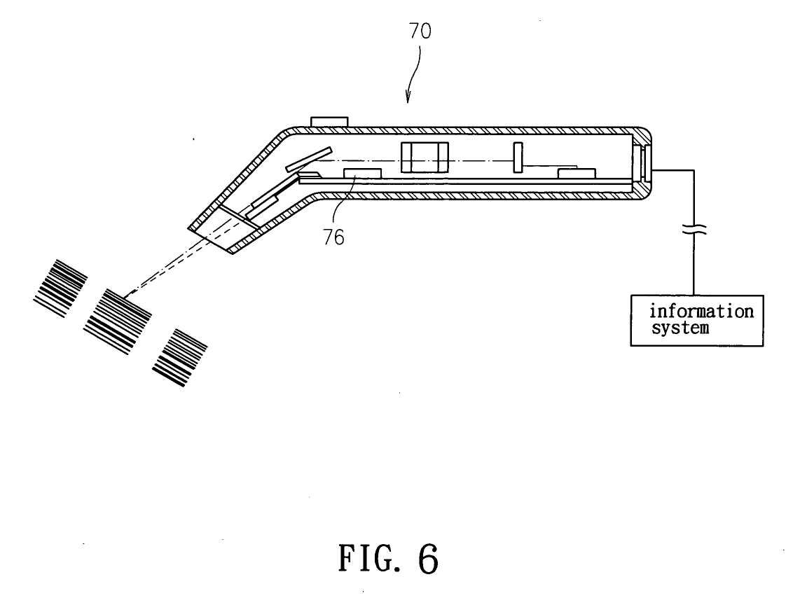

Finally, please refer to FIG. 6, a structural cross sectional diagram of an alternate embodiment of the present invention. The barcode reader 70 further has a motion sensing device 76 therein. The motion sensing device 76 can be used to replace the function of the sensing device (36/56) of the previous embodiments. When the barcode reader 70 is not used and idle for an interval T, the motion sensing device 76 will detect that the barcode reader 70 is in an idle state, and thus turns off the internal element power or scanning function of the barcode reader 70. On the other hand, if the barcode reader 70 moves or is in a using state, the motion sensing device 76 will sense the movement of the barcode reader 70 and notify the working power to keep supplying for all elements. This way can also achieve the inventive object and effect of the present invention.

While the sensing device in the previous embodiments of the present invention is described as a sensing device 36 and motion sensing device 76, in practice, the sensing device can also be a position sensing device or light source sensing device, etc., which will not be given unnecessary details. Further, the sensing device can be suitable to various readers, such as charge couple device (CCD) barcode reader, complementary metal oxide semiconductor (CMOS) barcode reader, CCD/CMOS hybrid barcode reader, charge injection device (CID) barcode reader, contact image sensor (CIS) barcode reader, laser barcode reader, or wand, etc.

Besides, the sensing device 36 of the previous embodiments can be integrated into the image sensor 37, and the information system 395/595 can be directly fixed into the barcode reader 30/50 for easy carrying the elements.

In summary, it is appreciated that the present invention is related to barcode reader and more particularly to a barcode reader which can automatically turn on or off the power or scanning function according to the usage. Not only the convenience in use is improved, but also the object of saving energy and increasing the lifetime of the barcode reader can be achieved. Therefore, the present invention should be granted a patent.

The foregoing description is merely one embodiment of present invention and not considered as restrictive. All equivalent variations and modifications in process, method, feature, and spirit in accordance with the appended claims may be made without in any way from the scope of the invention.

1. A barcode reader, comprising:
a light source module for generating a scanning light to scan a barcode, and automatically generating a reflection barcode signal after scanning said barcode;
an image sensor provided at a back end of said light source module for receiving and processing one of said reflection barcode signal and an incident light source signal from external input;
a data transferring device provided at a back end of said image sensor for transferring said barcode signal processed from said image sensor to an information system; and
a sensing device fixed in said barcode reader for sensing change of said incident light source signal during an interval period, as well as a dependence for said barcode reader operation power on/off.

2. The barcode reader according to claim 1, wherein said sensing device is capable of sensing said change of said incident light source signal during an interval period, as well as a dependence for said barcode reader scanning function on/off.

3. The barcode reader according to claim 1, wherein said reflection barcode signal is said incident light source signal.

4. The barcode reader according to claim 1, wherein said sensing device is selectively fixed in said information system.

5. The barcode reader according to claim 1, wherein said sensing device is selected from one of hardware and software program.

6. The barcode reader according to claim 1, wherein said sensing device consists of a software program collocating with said image sensor.

7. The barcode reader according to claim 1, wherein said barcode reader is selected from a fixed barcode reader and a movable barcode reader.

8. The barcode reader according to claim 1, wherein said information transferring device is connected to said information system via a transferring line.

9. The barcode reader according to claim 8, wherein said transferring line is selected from a wired transferring system and a wireless transferring system.

10. The barcode reader according to claim 1, wherein said sensing device is selected from a motion sensing device, a position sensing device, and a light source sensing device.

11. The barcode reader according to claim 10, wherein said motion sensing device is capable of sensing whether said barcode reader moves during an interval period, as well as a dependence for barcode reader operation power on/off.

12. The barcode reader according to claim 10, wherein said motion sensing device is capable of sensing whether said barcode reader moves during an interval period, as well as a dependence for said barcode reader scanning function on/off.

13. The barcode reader according to claim 1, wherein said light source module further comprises an aiming light.

14. The barcode reader according to claim 13, wherein said aiming light is automatically generated by responding to a sensing result of said sensing device.

15. The barcode reader according to claim 1 further comprising a switch for controlling said scanning light.

16. The barcode reader according to claim 1, wherein said sensing device can be integrated into said image sensor.
